(19) United States
(12) Patent Application Publication
(10) Pub. No.: US 2008/0014063 A1
(43) Pub. Date: Jan. 17, 2008

(54) Device for transporting a material strand

(75) Inventor: Richard Brussel, Sulzfeld (DE)

Correspondence Address: POSZ LAW GROUP, PLC, 12040 SOUTH LAKES DRIVE, SUITE 101, RESTON, VA, 20191, US

(73) Assignee: SCHMIDT & HEINZMANN GmbH & Co. KG, Bruchsal (DE)

(21) Appl. No.: 11/826,064

(22) Filed: Jul. 12, 2007

(30) Foreign Application Priority Data
Jul. 14, 2006 (DE) 10 2006 032 830.2

(51) Int. Cl. B65G 1/16; B65B 69/00

(52) U.S. Cl. 414/332; 414/811

(57) ABSTRACT

A device for transporting a material strand, in particular a sticky plastic material strand. The device includes a transport unit for transporting the material strand and a discharge unit for discharging a separating powder. The discharge unit is arranged to apply the separating powder directly onto an underside of the material strand.

### CROSS REFERENCE TO RELATED APPLICATION

The present application is based on, claims priority from, and incorporates by reference German Patent Application No. DE 10 2006 032 830.2.

### TECHNICAL FIELD

The invention relates to a device for transporting a material strand.

### BACKGROUND

A known device for transporting a material strand, in particular a thin and sticky plastic material strand, includes a transport unit for transporting the material strand. In addition, for the purpose of transporting the material strand, the device possesses a discharge unit which discharges a separating powder directly onto a transport belt of the transport unit.

### SUMMARY

A device in accordance with various exemplary embodiments enables a reduction in a sticky characteristic of at least one surface of the material strand.

In particular, a device is provided for transporting a thin and sticky plastic material strand, having a transport unit for transporting the material strand and a discharge unit for a separating powder.

It is proposed for the discharge unit to be so arranged as to apply the separating powder directly onto an underside of the material strand, whereby advantageously the adhesion of the material strand, in particular the adhesion of the thin, sticky plastic strand, to a transport belt of the transport unit can be reliably avoided. In this case, the expression “an underside of a material strand” should be understood to denote in particular that side of the material strand, the surface of which lies on the transport belt of the transport unit necessary for the transport of the material strand. The separating powder is advantageously applied to the underside of the material strand before the material strand is laid on the transport belt of the transport unit. Adhesion of the separating powder to the underside of the material strand is achieved advantageously in this case through the sticky nature of the material. The separating powder is appropriately non-adhesive to the transport belt of the transport unit, so that particularly easy separation can be achieved between the transport belt and the material strand. Paddle sheets, for example, which remove the material strand from the transport belt of the transport unit and transport it onwards for further processing, can handle the material strand without material losses by means of the separating powder. The material strand is preferably in the form of a plastic strand, in particular a fiber-reinforced and molten thermoplastic and/or a liquid resin, such as a thermosetting plastic, which provides a sticky surface for the material strand.

Furthermore, it is proposed for the discharge unit to include at least one nozzle, which sprays the separating powder onto the underside of the material strand, whereby a finely distributed and uniformly thick layer of the separating powder can be achieved on the underside of the material strand. In addition, the act of spraying the separating powder can permit advantageously simple application to the underside of the material strand.

Undesired cooling of the material strand can be avoided, and formability of the material strand can be retained, if the discharge unit is so arranged as to heat the separating powder before it is sprayed onto the underside of the material strand. Material strands, in particular plastic strands made of thermoplastics, are only formable or workable within a specific temperature range, so that the temperature of the material strand remains scarcely changed or unchanged by the heated separating powder that is applied by spraying. The separating powder in this case is heated advantageously to the temperature of the material strand. It is fundamentally possible, however, also to dispense with the heating of the separating powder, in particular in the case of a material strand made of a thermosetting plastic.

Proposed in a further embodiment is a method for transporting a material strand, in particular a thin and sticky plastic strand, having a device for transporting a material strand, in conjunction with which a separating powder is applied directly to an underside of the material strand. The adhesion of the material strand, in particular the thin and sticky plastic strand, to a transport belt of the transport unit can be advantageously avoided in this case, in that the separating powder adheres to the underside of the material strand before the material strand lies on the transport belt of the transport unit.

It is further proposed that the separating powder be heated together with a fluidizing air supply, by means of which moisture formation during heating of the separating powder can be avoided advantageously.

Agglomeration of the separating powder can also be counteracted in this case, since the separating powder together with the fluidization air is enabled to form a uniform and finely distributed fluid by means of the fluidization air.

A particularly finely distributed layer of separating powder on the underside of the material strand and simple metering of the separating powder in conjunction with its spray application can be achieved if the separating powder together with the fluidization air is applied by spraying onto the underside of the material strand. In addition, a separating powder layer of uniform thickness can be achieved on the underside of the material strand. Alternatively, or in addition, however, further methods for the application of the layer of separating powder to the underside of the material strand, which appear sensible to a person skilled in the art, are also conceivable.

A material of the separating powder is advantageously adapted to a material, in particular to a filler material, of the material strand, as a consequence of which material characteristics of the material strand remain unaffected by characteristics of the separating powder. The expression “adapted” in this case should be understood to denote in particular that at least individual component parts are executed in conformity. The expression “a filler material” should be understood in this context to denote a material that is added as a filler material to a mixture of substances with the intention of increasing its volume, but without modifying the characteristics of the mixture of substances significantly by so doing. Further materials, such as talc, calcium carbonate, etc., which leave the characteristics of the strand material unchanged or almost unchanged, and which appear sensible to a person skilled in the art, are fundamentally also conceivable as a separating powder, however.

It is proposed, furthermore, for the separating powder together with the material strand to be processed further, in conjunction with which a separation of the material strand and the separating powder can be avoided and additional production costs can thus be economized. The separating powder can be integrated into the material strand by pressing, for example, and a common strand can be achieved advantageously in this way and/or the separating powder can be cut advantageously together with the material strand, for example. Alternatively or additionally, further operations for processing the material strand together with the separating layer, which appear sensible to a person skilled in the art, are also conceivable.

Proposed in a further embodiment is a device for transporting a material strand, in particular a thin and sticky plastic strand, having a transport unit for transporting the material strand and a discharge unit, the discharge unit being so arranged as to apply a separating layer to an underside of the material strand. Adhesion of the material strand, such as the thin and sticky plastic layer in particular, to a component part provided for the transport and/or laying of the material strand, can be avoided advantageously in this way. Adhesion of the separating layer to the underside of the material strand is achieved advantageously in this case by a sticky characteristic of the material strand.

It is proposed, furthermore, for the discharge unit to be so arranged as to apply the separating layer between the underside of the material strand and the transport unit, whereby adhesion of the material strand to a transport belt of the transport unit can be avoided. The separating layer is advantageously non-adhesive to the transport belt of the transport unit, so that particularly easy separation can be achieved between the transport belt and the material strand. The separating layer in this case can first be laid on the transport belt, and the material strand can then be brought into contact with the separating layer, or the separating layer can first be brought into contact with the underside of the material strand, and can then be laid together with the material strand on the transport belt of the transport unit.

The discharge unit is advantageously so arranged as to apply the separating layer in heated form between the underside of the material strand and the transport unit, whereby undesired cooling of the material strand can be avoided and formability of the material strand can be retained. The separating layer is advantageously heated to a temperature of the material strand, so that the temperature and/or the formability of the material strand remain unaffected by the application of the separating layer.

Also proposed is a method for transporting a material strand, in particular a thin and sticky material strand, and in particular having a device for transporting a material strand, in conjunction with which a separating layer is applied to an underside of the material strand. Adhesion of the material strand, such as the thin and sticky plastic strand in particular, to a component part provided for the transport and/or for the laying of the material strand, can be avoided advantageously in this way. Adhesion of the separating layer to the underside of the material strand is achieved advantageously in this case by a sticky characteristic of the material strand.

The separating layer is applied advantageously in a heated form between the underside of the material strand and the transport unit, whereby undesired cooling of the material strand after contact with the separating layer can be avoided, and the material strand can thus maintain an advantageous temperature for further processing. Fundamentally, however, heating of the separating layer can also be dispensed with, as in the case of a material strand made of a thermoplastic in particular.

In addition, material characteristics of the material strand can advantageously remain unaffected by characteristics of the separating layer if a material of the separating layer is adapted to a material, in particular a filler material, of the material strand. The expression “adapted” in this case should be understood to denote in particular that at least individual component parts are executed in conformity with one another. The expression “a filler material” should be understood in this context to denote a material that is added as a filler material to a mixture of substances with the intention of increasing its volume, but without modifying the characteristics of the mixture of substances significantly in this case.

It is proposed, furthermore, for the separating layer to be in the form of a continuous substrate, whereby a continuous separating layer can be applied to the underside of the material strand in a particularly simple manner. The expression “a continuous substrate” should be understood in this context to denote a substrate that is executed in a singe piece, in particular a separating paper, a film, a nonwoven fabric and/or a woven fabric, made of glass, carbon, metal, natural and/or chemical fibers. In particular, the material strand can be handled simply by the continuous substrate in the course of further processing.

The continuous substrate is formed particularly advantageously from a nonwoven glass fiber fabric, whereby the substrate can be adapted particularly advantageously to a material of the material strand, in particular a glass fiber-reinforced material strand.

Furthermore, it is proposed for the separating layer together with the material strand to be further processed, whereby expensive separation of the material strand and the separating layer can be avoided and additional production costs can thus be economized. The separating layer together with the material strand can be cut in this way, for example, and/or the separating layer together with the material strand can be formed and/or compressed after transport in a pressing process. Alternatively or additionally, further processing operations of the material strand with the separating layer, which appear sensible to a person skilled in the art, are conceivable.

Further embodiments can be appreciated from the appended claims.

### BRIEF DESCRIPTION OF THE DRAWINGS

Further advantages will be appreciated from the accompanying descriptive drawings. Illustrative embodiments of the invention are depicted in the drawing. The drawings, the description and the claims contain numerous characterizing features in combination. A person skilled in the art will appropriately also consider the characterizing features individually and will combine them to produce sensible additional combinations. In the drawings:

FIG. 1 illustrates a device according to an exemplary embodiment for transporting a material strand depicted in a side view;

FIG. 2 illustrates a device for transporting a material strand as a second embodiment depicted in a side view; and

FIG. 3 illustrates an alternative discharge unit for the device shown in FIG. 2 depicted in a side view.

### DETAILED DESCRIPTION

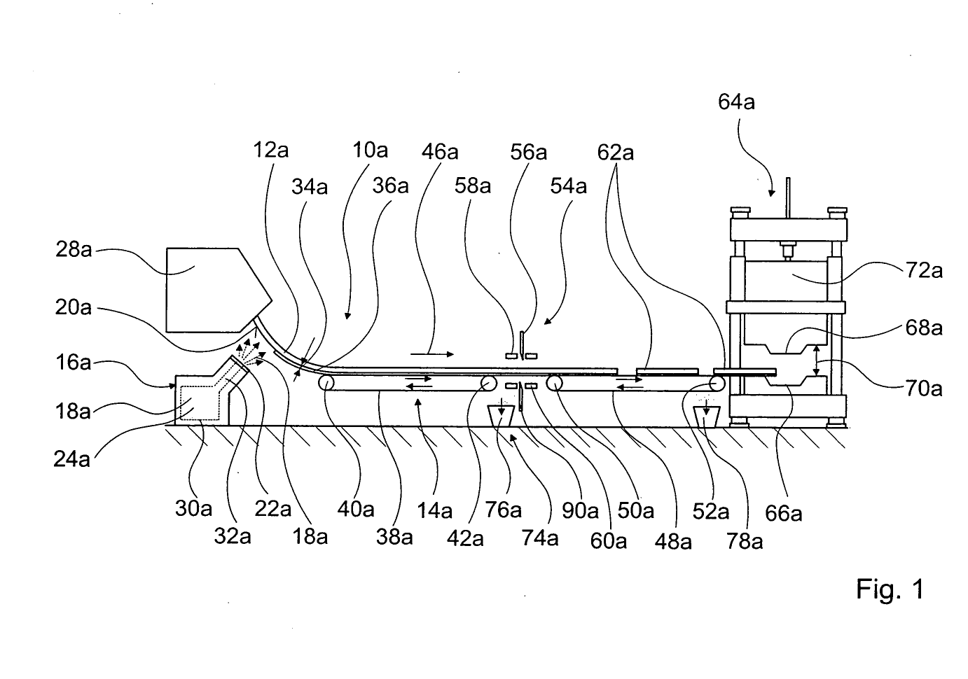

A device 10a for transporting a material strand 12a is illustrated in FIG. 1. The device 10a includes a transport unit 14a, which is arranged for transporting the material strand 12a, together with a discharge unit 16a and a unit 28a, which is arranged for the purpose of dispensing the material strand 12a. The material strand 12a emerges from the unit 28a in a molten state. The material strand 12a is formed from a thin and sticky plastic strand, for example a glass fiber-reinforced plastic strand.

The discharge unit 16a is arranged for the direct application of a separating powder 18a onto an underside 20a of the material strand 12a. The separating powder 18a in this case is adapted to a filler material of the material strand 12a or corresponds to a filler material of the material strand 12a, so that the material characteristics of the material strand 12a remain unaffected by the separating powder 18a.

The discharge unit 16a includes a nozzle 22a for the direct application of the separating powder 18a onto the underside 20a of the material strand 12a. In addition, the discharge unit 16a includes a heating chamber 30a, in which the separating powder 18a together with fluidization air 24a is heated to a temperature of the material strand 12a. For this purpose, the heating chamber 30a includes heating elements (not illustrated in more detail here), which heat the separating powder 18a together with the fluidization air 24a to the desired temperature, so that moisture formation during heating of the separating powder 18a is avoided advantageously. On reaching the temperature of the material strand 12a, the fluidization air 24a and the separating powder 18a are conveyed together via a channel 32a to the nozzle 22a of the discharge unit 16a. The separating powder 18a and the fluidization air 24a are sprayed together in finely distributed form onto the underside 20a of the sticky material strand 12a by means of the nozzle 22a. The separating powder 18a in this case is sprayed with a uniform layer thickness 34a onto the underside 20a of the material strand 12a. Adhesion between the separating powder 18a and the material strand 12a is achieved by a sticky surface of the underside 20a of the material strand 12a.

The material strand 12a with a separating powder layer 36a sprayed onto the underside 20a is then laid with its side exhibiting the separating powder layer 36a onto a transport belt 38a of the transport unit 14a. The transport unit 14a comprises two transport belts 38a, 48a, each with a drive roller body 40a, 50a, and each with a roller body 42a, 52a carried along by the drive roller body 40a, 50a. The transport belts 38a, 48a in this case are arranged one after the other, whereby these are tensioned in each case by the drive roller bodies 40a, 50a and the roller bodies 42a, 52a. During operation of the transport unit 14a, each of the transport belts 38a, 48a is driven via the drive roller bodies 40a, 50a. A direction of running of the transport belts 38a, 48a is indicated in FIG. 1 with arrows. The material strand 12a is transported away from the unit 28a in a direction 46a by means of the transport belts 38a, 48a. A belt speed for the transport belts 38a, 48a and a discharge rate for the material strand 12a of the unit 28a are advantageously matched to one another in this case.

The separating powder 18a includes a non-adhesive characteristic in relation to the surfaces of the transport belts 38a, 48a, so that adhesion of the material strand 12a to the transport belts 38a, 48a is prevented. The layer thickness 34a of the separating powder layer 36a on the underside 20a of the material strand 12a is designed in this case in such a way that it provides separation of the material strand 12a and the transport belts 38a, 48a for the duration of the transport of the material strand 12a on the transport belts 38a, 48a. If, following unrolling of the material strand 12a, residue of the separation powder 18a remains on the transport belts 38a, 48a, these are removed by a suction unit 74a. For this purpose, the suction unit 74a for each transport belt 38a, 48a includes a suction means 76a, 78a, which removes the residues of the separating powder 18a by suction at the ends of the transport belts 38a, 48a facing towards the roller bodies 42a, 52a in each case.

For further processing of the material strand 12a together with the separating powder 18a, there is arranged between the two transport belts 38a, 48a a cutting device 54a, so that, in conjunction with cutting of the material strand 12a, adhesion to one of the two transport belts 38a, 48a is avoided. The cutting device 54a is provided for the purpose of cutting the material strand 12a and comprises two cutting means 56a, 90a, in each case in the form of a cutting blade, and two blade guides 58a, 60a, each of which is provided for one of the cutting means 56a, 90a. For cutting, the material strand 12a together with the separating powder 18a is guided to the cutting device 54a and is parted by the cutting means 56a, 90a as they move up and down synchronously in relation to one another. In conjunction with this, one of the cutting means 56a, 90a in each case is guided in relation to the material strand 12a in a position necessary for cutting by means of one of the blade guides 58a, 60a in each case. Strand sections 62a that have been separated from the material strand 12a are transported onwards to a press device 64a by the transport belt 48a.

The press device 64a, which is provided for the compression molding of the individual strand sections 62a, includes a lower mold part 66a and an upper mold part 68a, which is movably arranged in relation to the lower mold part 66a along a vertical axis 70a. The upper mold part 68a is pressed by means of a hydraulically driven press element 72a onto the lower mold part 66a during a pressing operation by the press device 64a. Fundamentally, however, press devices driven mechanically and/or with compressed air are conceivable at any time in a further embodiment of the invention. If a strand section 62a is guided by the transport belt 48a of the transport unit 14a into the press device 64a and onto the lower mold part 66a, this is followed by the compression of the upper mold part 68a onto the lower mold part 66a by the press element 72a, and the strand section 62a is pressed together with the separating powder 18a adhering to the underside 20a into the desired form.

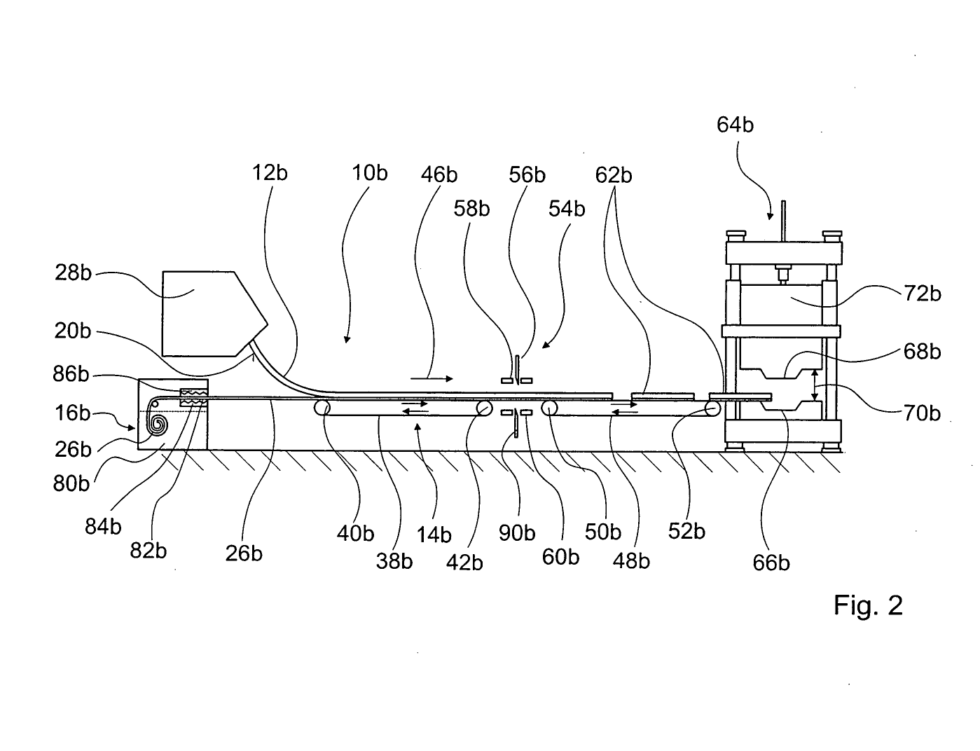

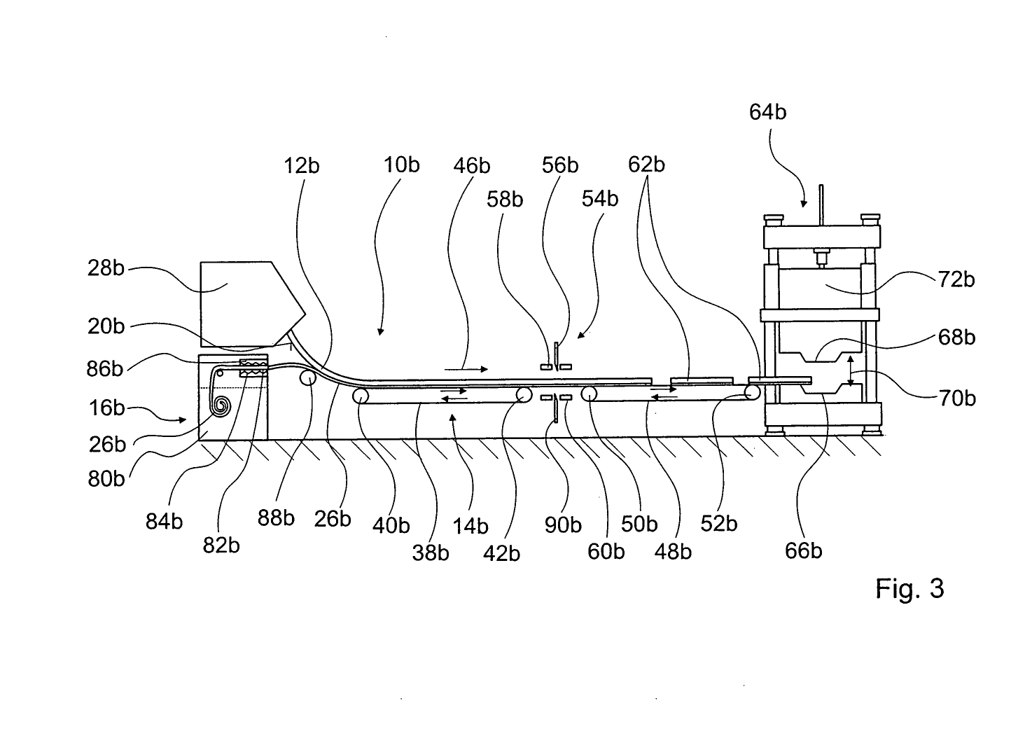

A further embodiment of the device 10b for transporting a material strand 12b is illustrated in FIGS. 2 and 3. Reference can be made to the description of the illustrative embodiments in FIG. 1 in respect of characteristic features and functions that remain the same. Component parts and characteristic features which correspond in essential respects are basically identified with the same reference designations, in conjunction with which the letters a (in FIG. 1) or b (in FIGS. 2 and 3) have been added to the reference designations for the purpose of distinguishing between the illustrative embodiments. The subsequent description in FIGS. 2 and 3 is restricted essentially to the differences from the illustrative embodiment in FIG. 1.

A device 10b for transporting a material strand 12b is illustrated in FIG. 2. The device 10b includes a transport unit 14b, which is arranged for transporting the material strand 12b, together with a discharge unit 16b and a unit 28b, which is arranged for the purpose of dispensing the material strand 12b. The material strand 12b emerges from the unit 28bin a molten state. The material strand 12b is in the form of a thin and sticky plastic strand, for example a glass fiber-reinforced plastic strand.

The discharge unit 16b is arranged for the dispensing of a separating layer 26b, which provides for the separation of the material strand 12b and a transport belt 38b, 48b of the transport unit 14b. The separating layer 26b in this case is in the form of a nonwoven glass fiber fabric, which provides a continuous and—where considered necessary—wall-to-wall substrate for the material strand 12b. The separating layer 26b formed by the nonwoven glass fiber fabric is advantageously adapted in this case to a reinforcing material for the material strand 12b formed from glass fiber.

The discharge unit 16b comprises a seat 80b, a discharge channel 82b and the transport belt 38b. The separating layer 26b is suspended in rolled-up form in the seat 80b and is unrolled in conjunction with its discharge. The separating layer 26b is discharged via the discharge channel 82b in an unrolled condition. The discharge channel 82b is surrounded for part of its section by heating elements 84b, 86b, which preheat the separating layer 26b to a temperature of the material strand 12b. The preheated separating layer 26b is applied to the transport belt 38b, and the material strand 12b is then laid with its underside 20b in front onto the separating layer 26b, so that the separating layer 26b is arranged between the material strand 12b and the transport belt 38b. The separating layer 26b in this case adheres to a sticky surface of the underside 20b of the material strand 12b. In addition, the separating layer 26b includes nonstick characteristics in relation to the transport belt 38b, so that adhesion between the material strand 12b and the transport belts 38b is prevented.

Further processing of the material strand 12b together with the separating layer 26b takes place via the transport unit 14b, a cutting device 54b and a pressing device 64b. Transporting, parting and pressing of the material strand 12b together with the separating layer 26b take place in this case in a manner that remains identical to the embodiments in FIG. 1.

Illustrated in FIG. 3 is an alternative embodiment to that illustrated in FIG. 2 for a discharge unit 16b for a separating layer 26b. The discharge unit 16b in this case comprises a seat 80b, a discharge channel 82b and a roller body 88b. A separating layer 26b is applied in this case through the discharge unit 16b directly onto an underside 20b of a material strand 12b. The separating layer 26b is suspended in rolled-up form in the seat 80b and is unrolled in conjunction with its discharge. The separating layer 26b is discharged via the discharge channel 82b in an unrolled condition. The discharge channel 82b is surrounded for part of its section by heating elements 84b, 86b, which preheat the separating layer 26b to a temperature of the material strand 12b. The preheated separating layer 26b is applied directly to the underside 20b of the material strand 12b via the roller body 88b. The roller body 88b, by which the separating layer 26b is guided to the material strand 12b, causes the separating layer 26b to be pressed against the underside 20b of the material strand 12b. The separating layer 26b adheres to the material strand 12b through a sticky surface of the underside 20b of the material strand 12b. The material strand 12b is then laid with a side exhibiting the separating layer 26b in front onto a transport belt 38b of the transport unit 14b, so that adhesion of the material strand 12b to the transport belt 38b is prevented.

The invention is described herein in detail with particular reference to presently preferred exemplary embodiments. However, it will be understood that variations and modifications can be effected within the scope and spirit of the invention.

What is claimed is:

1. A device for transporting a sticky plastic material strand, comprising:
a transport unit for transporting the material strand; and
a discharge unit for applying a separating powder to the material strand, wherein
the discharge unit is so arranged as to apply the separating powder directly onto an underside of the material strand.

2. The device according to claim 1, wherein the discharge unit includes at least one nozzle for spraying the separating powder onto the underside of the material strand.

3. The device according to claim 2, wherein the discharge unit is so arranged as to heat the separating powder before it is sprayed onto the underside of the material strand.

4. A method for transporting a sticky plastic material strand, comprising:
applying a separating powder directly to an underside of the material strand; and
transporting the material strand.

5. The method according to claim 4, further comprising heating the separating powder together with fluidization air.

6. The method of claim 5, further comprising spraying the separating powder together with the fluidization air onto the underside of the material strand.

7. The method of claim 4, wherein a material of the separating powder is adapted to a material of the material strand.

8. The method of claim 4, wherein the separating powder together with the material strand is further processed.

9. A device for transporting a sticky plastic material strand, comprising:
a transport unit for transporting the material strand; and
a discharge unit being arranged to apply a separating layer onto an underside of the material strand.

10. The device according to claim 9, wherein the discharge unit is arranged to apply the separating layer between the underside of the material strand and the transport unit.

11. The device according to claim 9, wherein the discharge unit is arranged to apply the separating layer in heated form between the underside of the material strand and the transport unit.

12. A method for transporting a sticky plastic material strand, comprising:
applying a separating layer to an underside of the material strand; and
transporting the sticky plastic material strand.

13. The method according to claim 12, wherein the applying a separating layer to an underside of the material strand comprises applying the separating layer in heated form between the underside of the material strand and the transport unit.

14. The method according to claim 12, wherein a material of the separating layer is adapted to a material of the material strand.

15. The method according to claim 12, wherein the separating layer is in the form of a continuous substrate.

16. The method according to claim 12, wherein the continuous substrate is formed from a nonwoven glass fiber fabric.

17. The method according to claim 12, wherein the separating layer together with the material strand is further processed.

18. The method according to claim 12, further comprising compressing the separating layer with the material strand.
